(19) United States
(12) Patent Application Publication
(10) Pub. No.: US 2022/0114225 A1
(43) Pub. Date: Apr. 14, 2022

(54) INFLUENCE MAXIMIZATION ON SOCIAL NETWORKS WITH TENSOR BANDITS

(71) Applicant: International Business Machines Corporation, Armonk, NY (US)

(72) Inventors: Keerthiram Murugesan, White Plains, NY (US); Tsuyoshi Ide, Harrison, NY (US); Djallel Bouneffouf, Wappinger Falls, NY (US)

(21) Appl. No.: 17/069,829

(22) Filed: Oct. 13, 2020

(51) Int. Cl. G06F 16/9536; G06Q 50/00; G06N 5/02

(52) U.S. Cl. CPC G06F 16/9536; G06N 20/00; G06N 5/022; G06Q 50/01

(57) ABSTRACT

A computer-implemented method, a computer program product, and a computer system for influence maximization on a social network. A computing device or server receives a graph of a social network and a user contextual tensor. With a tensor regression model, the computing device or server predicts activation probabilities of respective first users influencing respective second users, using a tensor inner product of the user contextual tensor and a susceptibility tensor and using an upper confidence bound. The computing device or server determines a set of seed users that maximizes influence in the social network, based on the activation probabilities. The computing device or server updates the susceptibility tensor by machine learning, based on user responses online and the user contextual tensor. The computing device or server updates the activation probabilities and the set of the seed users, based on an updated susceptibility tensor.

### BACKGROUND

The present invention relates generally to influence maximization on social networks, and more particularly to a framework with tensor bandits and an upper confidence bound for influence maximization (IM).

The remarkable success of targeted advertising campaigns in social networking platforms has brought about new challenges in data management. The number of nodes (representing users) in a social graph may be in the millions, and the number of edges between the nodes in the billions or more. Critical information on buying behaviors of the users is typically unknown. Data analysts have no choice but to accumulate such information step by step through iterative interactions with the social network. These characteristics make targeted marketing a rich and challenging research area in the field of exploratory data analysis (EDA). Specifically, user group analytics (UGA) with emphases on social networks has attracted considerable attention as an emerging sub-field of EDA in the database research community.

A central problem in UGA can be naturally formalized as the budgeted version of the IM problem. The goal in IM is to find an optimal set of seed users such that the influence passed on to the other users is maximized. In online marketing, for example, given a social graph [symbol] and a budget K, the marketing agency chooses K seed users from the graph nodes and makes certain offers (e.g., promotions and giveaways), with the expectation that the seed users will influence their followers and spread the awareness about the product(s). Part of the challenge lies in the fact that this needs to be achieved in the absence of apriori information to guide the seed user selection, through iterative interactions (or queries) into the social network (or associated database as its proxy).

The original influence maximization (IM) problem was formulated as that of choosing an optimal set of seed users so as to maximize the overall influences given a social graph and the activation probabilities {pᵢⱼ} (the probability for the i-th user to activate the j-th user) where these probabilities are known ahead of time. However, such information is not readily available in many real world application scenarios of interest including online marketing. A new dynamic formulation of the IM problem, in which the activation probabilities need to be learned as part of the overall process, has emerged. Specifically, a framework based on the so called contextual bandit (CB) problem has gained significant attention. In the CB-based IM, the candidate seed users (corresponding to bandit arms) are chosen based on information on the users such as the demographics (corresponding to the context). Viewing the original IM problem of determining a (near) optimal set of seed users given complete activation probabilities as the static UGA problem, the CB-based formulation of IM can be viewed as a dynamic approach to UGA, in which access is made with the social network via queries that return the seed users given current activation probability estimates.

In the machine learning community, two major CB-based IM approaches have been proposed to date. One is regression-based and the other is factorization-based. In both cases, a main task is to compute {pᵢⱼ} from observed user responses and context vectors in an online fashion. In the former, the user response is regressed with a feature vector associated with each of the users or user pairs, while in the latter a data matrix collecting historical records of users' responses is factorized to predict a new user response. Although encouraging results have been reported in these works, there is one major limitation that prevents them from being a truly useful tool for UGA in practice. The major limitation is the lack of capability of handing the heterogeneity over different products in real-time. This is critical since marketing campaigns typically include many different products and strategies.

One previous disclosure (Chen et al., Combinatorial Multi-Armed Bandit and Its Extension to Probabilistically Triggered Arms, Journal of Machine Learning Research, 2016) formulates the influence maximization problem as a combinatorial bandit and proposed an algorithm to estimate the activation probabilities in an online fashion while ignores the contextual features available in many social graphs. In another previous disclosure (Vaswani et al., Model-Independent Online Learning for Influence Maximization, Proceedings of the 34th International Conference on Machine Learning, 2017) a diffusion independent CB-based IM framework DILinUCB is proposed. DILinUCB uses user-specific contextual features with linear regression. Unfortunately, DILinUCB learns user latent parameters for each node in the network and requires sufficient exploration of each node to achieve expected performance. Unlike in previous work, DILinUCB learns pairwise reachability between a pair of nodes, which requires tracing the influence propagation from the seed users to every other user in the network. Most previous methods such as DILinUCB consider direct influence between users related in networks. In yet another disclosure (Wen et al., Online Influence Maximization under Independent Cascade Model with Semi-Bandit Feedback, 31st Conference on Neural Information Processing Systems, 2017), a similar regression-based approach IMLinUCB with edge-specific features is proposed; however, in practice, such edge-specific features can be difficult to obtain in many applications as the edge-specific interaction may be sparse. In yet another disclosure (Wu et al., Factorization Bandits for Online Influence Maximization, 25th ACM SIGKDD Conference on Knowledge Discovery and Data Mining, 2019), another CB-based IM approach called IMFB is proposed; IMFB exploits matrix factorization to estimate {pᵢⱼ}. A framework called COIN is proposed (Saritac et al., Online Contextual Influence Maximization in Social Networks, Fifty-fourth Annual Allerton Conference, 2016). The framework COIN uses contextual features representing the product being advertised; however, it amounts to building an individual model for each product groups independently and cannot account for the users' preferences. Although these above-mentioned methods aim to incorporate the contextual information of the users, they cannot leverage the heterogeneity and similarity over different products. The bilinear contextual bandit is proposed (Jun et al., Bilinear Bandits with Low-rank Structure, Proceedings of the 36th International Conference on Machine Learning, 2019). The bilinear model is built entirely upon matrix-specific operations such as singular value decomposition (SVD); therefore, it is not applicable to general settings having more than two contextual vectors.

For the exploration-exploitation tradeoff, which is one of the key enablers for EDA, probabilistic output is required. For generic tensor regression methods, little is known about online inference of probabilistic tensor regression. Most of the existing probabilistic tensor regression methods require Monte Carlo sampling that is challenging to integrate with an upper confidence bound (UCB) framework; such methods include those based on Gaussian process regression (Imaizumi et al., Doubly Decomposing Nonparametric Tensor Regression, Proceedings of the 33rd International Conference on Machine Learning, 2016; Kanagawa et al., Gaussian Process Nonparametric Tensor Estimator and Its Minimax Optimality, Proceedings of the 33rd International Conference on Machine Learning, 2016; Zhao et al., Tensor-Variate Gaussian Processes Regression and Its Application to Video Surveillance, 2014 IEEE International Conference on Acoustic, Speech and Signal Processing, 2014) and hierarchical Bayesian models (Guhaniyogi et al., Bayesian Tensor Regression, Journal of Machine Learning Research 18, 2017; Idé, Tensorial Change Analysis Using Probabilistic Tensor Regression, Thirty-Third AAAI Conference on Artificial Intelligence, 2019). It has not been found to extend these algorithms to allow online updates.

### SUMMARY

In one aspect, a computer-implemented method for influence maximization on a social network is provided. The computer-implemented method includes receiving a graph of a social network and a user contextual tensor. The computer-implemented method further includes predicting activation probabilities of respective first users influencing respective second users, with a tensor regression model, using a tensor inner product of the user contextual tensor and a susceptibility tensor and using an upper confidence bound. The computer-implemented method further includes determining a set of seed users that maximizes influence in the social network, based on the activation probabilities. The computer-implemented method further includes updating the susceptibility tensor by machine learning, based on user responses online and the user contextual tensor. The computer-implemented method further includes updating the activation probabilities and the set of the seed users, based on an updated susceptibility tensor.

The computer-implemented method further includes: receiving the graph of the social network, respective user feature vectors, and parameters; initializing respective posterior means and respective posterior covariance matrices of respective coefficient vectors of respective tensor ranks for the respective contextual vectors. The computer-implemented method further includes: receiving one or more respective product contextual vectors; for respective edges connecting the respective first users and the respective second users in the graph of the social network, computing respective estimated scores of respective responses of the respective first users and the respective second users, based on the respective posterior means and the respective contextual vectors; computing respective ones of the activation probabilities with respect to the respective edges; obtaining an activation probability matrix, based on the respective activation probabilities; determining the set of the seed users that maximize the influence, based on the probability matrix and a maximum number of the seed users; and determining whether a predetermined number of rounds of online updates is reached.

In determining that the predetermined number of the rounds of the online updates is reached, the computer-implemented method further includes determining a final set of the seed users that maximize the influence. In determining that the predetermined number of the rounds of the online updates is not reached, the computer-implemented method further includes: obtaining observed online data of user responses of the set of the seed users; updating the respective posterior covariance matrices, based on the respective user feature vectors and the one or more respective product contextual vectors; updating the respective posterior means, based on respective updated posterior covariance matrices and the observed online data of the user responses of the set of the seed users; and executing a round of an online update, based on the respective updated posterior covariance matrices and respective updated posterior means.

In the computer-implemented method, for computing respective ones of the activation probabilities, a projection operation maps respective sums of the respective estimated scores and respective upper confidence bounds to a space of [0, 1].

In the present invention, one of advantages of the computer-implemented method is that the tensor regression model captures heterogeneity over different products.

In another aspect, a computer program product for influence maximization on a social network is provided. The computer program product comprises a computer readable storage medium having program instructions embodied therewith, and the program instructions are executable by one or more processors. The program instructions are executable to: receive a graph of a social network and a user contextual tensor; predict activation probabilities of respective first users influencing respective second users, with a tensor regression model, using a tensor inner product of the user contextual tensor and a susceptibility tensor and using an upper confidence bound; determine a set of seed users that maximizes influence in the social network, based on the activation probabilities; update the susceptibility tensor by machine learning, based on user responses online and the user contextual tensor; and update the activation probabilities and the set of the seed users, based on an updated susceptibility tensor.

In the computer program product, the program instructions are further executable to receive the graph of the social network, respective user feature vectors, and parameters. The program instructions are further executable to initialize respective posterior means and respective posterior covariance matrices of respective coefficient vectors of respective tensor ranks for the respective contextual vectors. The program instructions are further executable to receive one or more respective product contextual vectors. For respective edges connecting the respective first users and the respective second users in the graph of the social network, the program instructions are further executable to compute respective estimated scores of respective responses of the respective first users and the respective second users, based on the respective posterior means and the respective contextual vectors. The program instructions are further executable to: compute respective ones of the activation probabilities with respect to the respective edges; obtain an activation probability matrix, based on the respective activation probabilities; and determine the set of the seed users that maximize the influence, based on the probability matrix and a maximum number of the seed users. The program instructions are further executable to determine whether a predetermined number of rounds of online updates is reached. In determining that the predetermined number of the rounds of the online updates is reached, the program instructions are further executable to determine a final set of the seed users that maximize the influence.

In computer program product, in determining that the predetermined number of the rounds of the online updates is not reached, the program instructions are further executable to: obtain observed online data of user responses of the set of the seed users; update the respective posterior covariance matrices, based on the respective user feature vectors and the one or more respective product contextual vectors; update the respective posterior means, based on respective updated posterior covariance matrices and the observed online data of the user responses of the set of the seed users; and execute a round of an online update, based on the respective updated posterior covariance matrices and respective updated posterior means.

In one embodiment of the computer program product, for computing respective ones of the activation probabilities, a projection operation maps respective sums of the respective estimated scores and respective upper confidence bounds to a space of [0, 1].

In the present invention, one of advantages of the computer program product is that the tensor regression model captures heterogeneity over different products.

In yet another aspect, a computer system for influence maximization on a social network is provided. The computer system comprises one or more processors, one or more computer readable tangible storage devices, and program instructions stored on at least one of the one or more computer readable tangible storage devices for execution by at least one of the one or more processors. The program instructions are executable to receive a graph of a social network and a user contextual tensor. The program instructions are further executable to predict activation probabilities of respective first users influencing respective second users, with a tensor regression model, using a tensor inner product of the user contextual tensor and a susceptibility tensor and using an upper confidence bound. The program instructions are further executable to determine a set of seed users that maximizes influence in the social network, based on the activation probabilities. The program instructions are further executable to update the susceptibility tensor by machine learning, based on user responses online and the user contextual tensor. The program instructions are further executable to update the activation probabilities and the set of the seed users, based on an updated susceptibility tensor.

In the computer system, the program instructions are further executable to: receive the graph of the social network, respective user feature vectors, and parameters; initialize respective posterior means and respective posterior covariance matrices of respective coefficient vectors of respective tensor ranks for the respective contextual vectors; receive one or more respective product contextual vectors; for respective edges connecting the respective first users and the respective second users in the graph of the social network, compute respective estimated scores of respective responses of the respective first users and the respective second users, based on the respective posterior means and the respective contextual vectors; compute respective ones of the activation probabilities with respect to the respective edges; obtain an activation probability matrix, based on the respective activation probabilities; determine the set of the seed users that maximize the influence, based on the probability matrix and a maximum number of the seed users; and determine whether a predetermined number of rounds of online updates is reached.

In the computer system, in determining that the predetermined number of the rounds of the online updates is reached, the program instructions are further executable to determine a final set of the seed users that maximize the influence.

In the computer system, in determining that the predetermined number of the rounds of the online updates is not reached, the program instructions are further executable to: obtain observed online data of user responses of the set of the seed users; update the respective posterior covariance matrices, based on the respective user feature vectors and the one or more respective product contextual vectors; update the respective posterior means, based on respective updated posterior covariance matrices and the observed online data of the user responses of the set of the seed users; and execute a round of an online update, based on the respective updated posterior covariance matrices and respective updated posterior means.

In the computer system, for computing respective ones of the activation probabilities, a projection operation maps respective sums of the respective estimated scores and respective upper confidence bounds to a space of [0, 1].

### BRIEF DESCRIPTION OF THE SEVERAL VIEWS OF THE DRAWINGS

FIG. 1 is a systematic diagram illustrating a framework with tensor bandits and an upper confidence bound for influence maximization (IM), in accordance with one embodiment of the present invention.

FIG. 2 presents a flowchart showing operational steps of a framework with tensor bandits and an upper confidence bound for influence maximization (IM), in accordance with one embodiment of the present invention.

FIG. 3 presents an algorithm of using a tensor regression model and online updates for influence maximization (IM), in accordance with one embodiment of the present invention.

FIG. 4 presents a flowchart showing detailed operational steps of using a tensor regression model and online updates for influence maximization (IM), in accordance with one embodiment of the present invention.

FIG. 5 presents a first experimental result of using a framework with tensor bandits and an upper confidence bound for influence maximization (IM) and comparison of the first experimental result with results of baselines, in accordance with one embodiment of the present invention.

FIG. 6 presents a second experimental result of using a framework with tensor bandits and an upper confidence bound for influence maximization (IM) and comparison of the second experimental result with results of baselines, in accordance with one embodiment of the present invention.

FIG. 7 is a diagram illustrating components of a computing device or server, in accordance with one embodiment of the present invention.

FIG. 8 depicts a cloud computing environment, in accordance with one embodiment of the present invention.

FIG. 9 depicts abstraction model layers in a cloud computing environment, in accordance with one embodiment of the present invention.

### DETAILED DESCRIPTION

Embodiments of the present invention represent a latest attempt in broader efforts in developing a principled approach to knowledge refinement in exploratory data analysis (EDA), based on reinforcement learning (RL) and its simpler variants such as contextual bandit (CB). Embodiments of the present invention propose TensorUCB, a framework with tensor bandits and an upper confidence bound for influence maximization (IM). TensorUCB can flexibly handle the heterogeneity of the products and users. Unlike the prior work using RL and CB for EDA, embodiments of the present invention use a contextual tensor as the input data, which makes it possible to handle any number of feature vectors.

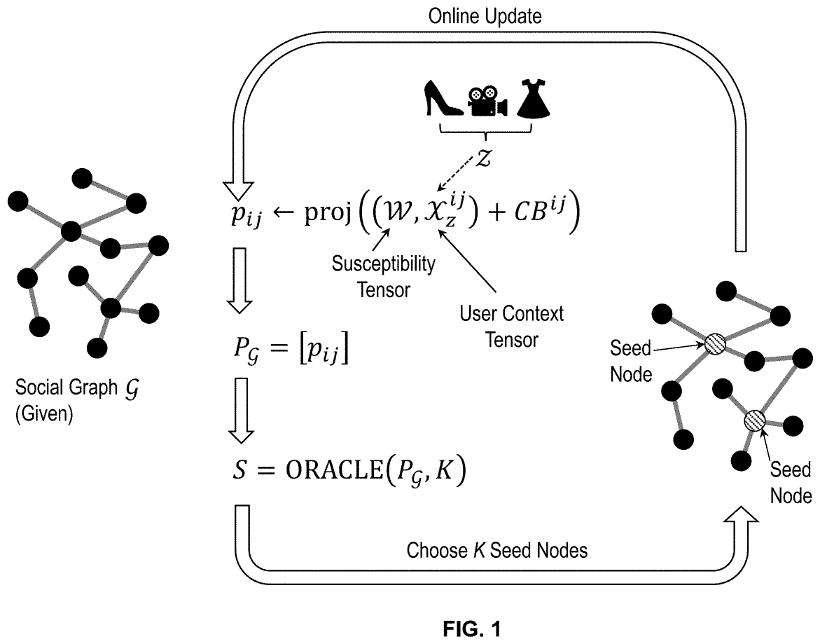

FIG. 1 illustrates a framework with tensor bandits and an upper confidence bound for influence maximization (IM), in accordance with one embodiment of the present invention. Given a social graph [symbol] , the goal of IM is to identify K seed users for an advertising campaign that influences the maximum number of the other users. The input quantity is a user context tensor X_{z}^{xj} that is formed from three feature vectors: user feature vectors of the i-th user and j-th user, and a product feature vector z. The user context tensor X_{z}^{xj} is used to predict the user response with a tensor regression model. Another tensor called the susceptibility tensor W plays a role of regression coefficients in the tensor regression model. The tensor regression model is designed to capture the heterogeneity over different products (such as shoes, movies, and cloths), the preferences of different users, marketing campaign strategies, and etc. Since W is unknown, it needs to be learned from user feedback or database queries in an online manner. To address exploration-exploitation trade-off in EDA, the predicted user feedback is combined with an upper confidence bound (UCB) framework. This is reflected in the introduction of CB_{z}^{i,j} shown in FIG. 1. The user response yᵢⱼ is predicted by the tensor regression model and the introduced CB_{z}^{ij}: (W, X_{z}^{ij}) CB_{z}^{ij}, where (W, X_{z}^{ij}) denotes the tensor inner product. Activation probabilities {pᵢⱼ} (pᵢⱼ is the probability for the i-th user to activate the j-th user) are obtained by an projection operation:

pᵢⱼ←proj((W,X_{z}^{ij})+CB_{z}^{ij}). (1)

Once the activation probability matrix [symbol] =[pᵢⱼ] is obtained, a submodular maximization algorithm chooses K most influential users. The submodular maximization algorithm in the present invention is denoted as ORACLE which is a query function returning the set of K users that maximizes the influence and it is a function of K and the activation probability matrix [symbol] :

S=ORACLE( [symbol] ,K), (2)

where S denotes the set of K selected users.

A user group (K most influential users) that maximizes the influence over the other users are chosen based on the activation probabilities {pᵢⱼ}. In an online update, based on newly acquired user responses yᵢⱼ (response of j-th user under influence of i-th user), the activation probabilities {pᵢⱼ} are updated using tensor regression formulas. Then, a new activation probability matrix is obtained, and ORACLE returns a new set of K users. A further round of online update may continue for a predetermined number of rounds.

Embodiments of the present invention apply contextual tensors to the task of IM. To address the potential complexity issues due to the tensorial structure of contextual information, embodiments of the present invention propose an online inference algorithm built upon the variational Bayes mean-field approximation. Using tensor regression formulation, the approach proposed in the present invention takes advantage of any number of contextual vectors. Furthermore, the derived online updates for {pᵢⱼ} do not require expensive matrix-specific operations, due to the use of the variational Bayesian approximation. The theoretical analysis for the proposed algorithm shows that it has a linear dependence on the number of nodes in the network which may be in the millions. The experimental results show that the proposed methods outperformed several state-of-the-art baselines under different contextual settings.

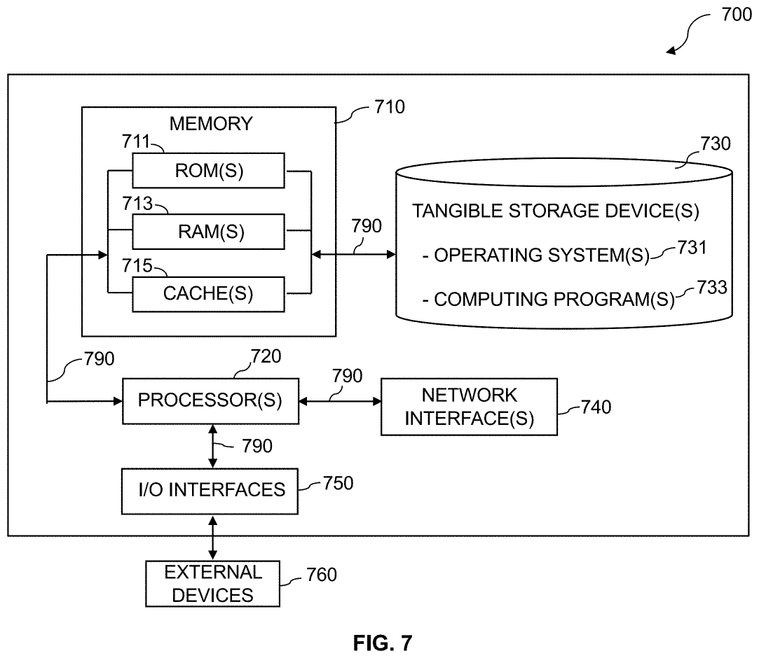

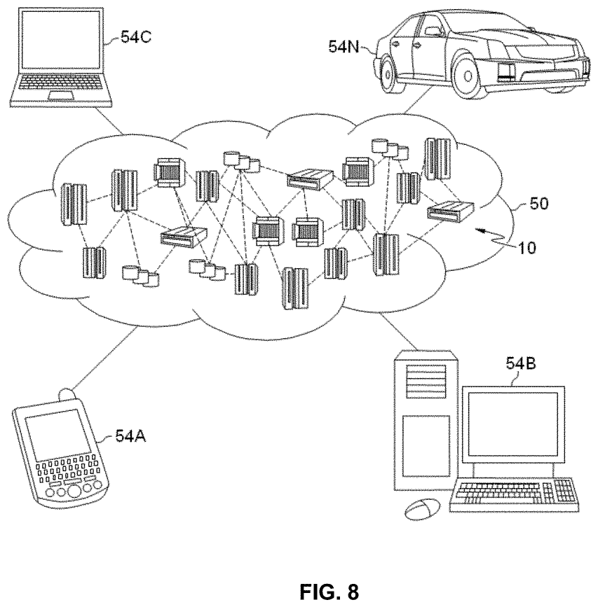

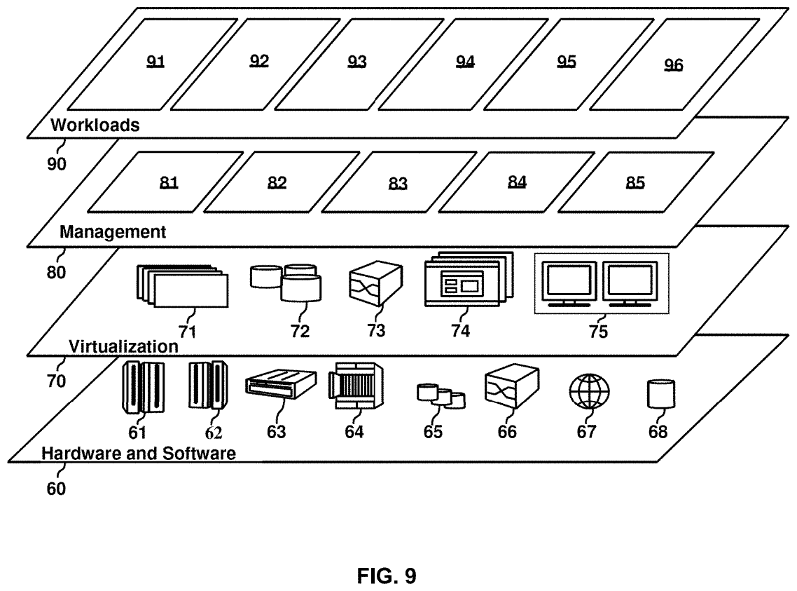

The framework with tensor bandits and an upper confidence bound for influence maximization (IM) is implemented on one or more computing devices or servers. A computing device or server is described in more detail in later paragraphs with reference to FIG. 7. In another embodiment, the operational steps may be implemented on a virtual machine or another virtualization implementation being run on one or more computing devices or servers. In yet another embodiment, the operational steps may be implemented in a cloud computing environment. The cloud computing environment is described in later paragraphs with reference to FIG. 8 and FIG. 9.

Problem Setting:

The goal of IM is to choose K users that have the maximum influence over the other users in a given social graph [symbol] . There are three major tasks in the automated exploration-exploitation data analysis using the framework with tensor bandits and an upper confidence bound: (1) an estimation model for yᵢⱼ, the user feedback of the j-th user by the influence of the i-th user, (2) a scoring model for pᵢⱼ, the probability that the i-th user activates the j-th user, and (3) a user selection model to choose the K most influential users given the scores pᵢⱼ.

For the third task, the submodular maximization algorithm denoted as ORACLE achieves a near-optimal solution with the

$$η = ( 1 - \frac{1}{e} - ɛ )$$

approximation, where e is the base of the natural logarithm and cis a positive real number (Nemhauser et al., An Analysis of Approximations for Maximizing Submodular Set Functions—I, Mathematical Programming, 1978; Golovin et al., Adaptive submodularity: Theory And Applications in Active Learning and Stochastic Optimization, Journal of Artificial Intelligence Research, 2011). For an actual implementation of ORACLE, the present invention adopts the algorithm proposed in a previous disclosure (Tang et al., Influence Maximization: Near-Optimal Time Complexity Meets Practical Efficiency, SIGMOD'14, 2014).

The social graph [symbol] =(ν, ε) is given, where ν is the set of user nodes and ε is the set of edges representing the friendship between the users. The number of nodes is denoted as |ν|. Based on an initialized {pᵢⱼ|(i,j)∈ε}, multiple rounds of marketing campaigns or online updates of {pᵢⱼ} are performed; the multiple rounds are indexed with t=1, 2, . . . , T. T is a predetermined number of online update rounds or marketing rounds.

Two types of observable data are considered in automated exploration-exploitation data analysis using the framework with tensor bandits framework with tensor bandits and an upper confidence bound for influence maximization (IM). The first is contextual information, or contextual or feature vectors. In a simple embodiment, there is a contextual or feature vector of the product being targeted, denoted by z, and a pair of user contextual or feature vectors for each selected user pair (i, j), denoted by xᵢ and xⱼ, corresponding to a sender and a receiver of the influence, respectively. In a more general embodiment, there are N_{F} contextual or feature vectors related to products, for example, for different products and/or marketing strategies, and N_{F} contextual or feature vectors are denoted as z¹, z², . . . , z^{N}^{_{F}}. Thus, a set of contextual vectors is {xᵢ, xⱼ, z¹, z², . . . , z^{N}^{_{F}}}. In the simple embodiment, N_{F}=1.

The second observable data is feedback of the users, denoted by yᵢⱼ ∈{0, 1} for the set of contextual vectors {xᵢ, xⱼ, z¹, z², . . . , z^{N}^{_{F}}} yᵢⱼ=1 if the j-th user has been influenced by the i-th user and yᵢⱼ=0 otherwise. Although yᵢⱼ is not directly measurable in general, a widely-used heuristic is the time-window-based method. Specifically, yᵢⱼ is set to be 1 for the pair (i, j) if (1) the j-th user bought the product after actively communicating with the i-th user and (2) the time when i contacted j is close enough to the time of purchase. Active communications include “likes,” retweeting, and commenting, depending on the social networking platforms. The size of the time window is determined by domain experts and is assumed to be given.

Sₜ is a set of seed users at t and its size |Sₜ|=K. Observed data is as follows:

[symbol]

ₜ [symbol] {(y_{t,ij},xᵢ,xⱼ)|∈Sₜ,j˜i}+{zₜ¹, . . . ,zₜ^{N}^{_{F}}}, (3)

where y_{t,ij} ∈{0, 1} is the response from the j-th user based on the influence of the i-th user at t. The symbol “j˜i” means “the j-th node is connected to i-th node”. In this document, random variables and their realizations are distinguished with a subscript. For example, y_{t,ij} is a realization of the random variable yᵢⱼ.

As mentioned earlier, one of the major tasks is to estimate the activation probability matrix:

[symbol]

[symbol]

[pᵢⱼ]i,j=1,2, . . . ,|V|. (4)

For any pair of disconnected users, pᵢⱼ=0. pᵢⱼ is computed from the user response yᵢⱼ. Because of the trial-and-error nature of marketing campaigns, this estimation of yᵢⱼ has to be done in an online manner. The prediction function (at any round t) is written as

yᵢⱼ≈uᵢⱼ=H_{w}(xᵢ,xⱼ,z₁,z₂, . . . ,z_{N}_{_{F}}) (5)

where uᵢⱼ∈ [symbol] ( [symbol] is a set of real numbers) is an estimated score for yᵢⱼ ∈{0,1} and W symbolically denotes the model parameter. Based on an assumed parametric model H_{w} and each of the observations in [symbol] ₜ (shown equation (3)), a goal is to obtain an updating rule of the form:

Wₜ←h(Wₜ₋₁, [symbol] ₜ), (6)

where Wₜ is the model parameter learned based on the data available up to the t-th round, and h is a function that is to be derived from Once feedback y_{t,ij} is obtained, p_{t,ij} is computed.

Tensor Regression Model:

First, a simplest case is considered; the simplest case is as illustrated in FIG. 1, where N_{F}=1. When the j-th user is activated by the i-th user for a given product, it is naturally assumed that the activation probability depends on attributes of the user i and user j and attributes of the product. Suppose that user i and user j are associated with d₁-dimensional feature vector xᵢ ∈ [symbol] ^{d}^{₁} and xⱼ ∈ [symbol] ^{d}^{₁} respectively and the product is associated with a d_{z}-dimensional feature vector z ∈ [symbol] ^{d}^{_{z}}. The task of learning pᵢⱼ can be viewed as a regression problem, where the user response yᵢⱼ is estimated as a function of xᵢ, xⱼ, z as shown in equation (5) and then the true response yᵢⱼ is used to compute pᵢⱼ. It is assumed that the parametric model H_{w} is given by a tensor regression representation, such that

$${y}_{i j} \approx {u}_{i j} = ( W , {X}_{z}^{i j} ) = {\sum }_{{i}_{1}}^{{d}_{1}} {\sum }_{{i}_{2}}^{{d}_{1}} {\sum }_{{i}_{3}}^{{d}_{z}} {\vert W \vert}_{{i}_{1} , {i}_{2} , {i}_{3}} {\vert {X}_{z}^{i j} \vert}_{{i}_{1} , {i}_{2} , {i}_{3}} \qquad ( 7 )$$

where uᵢⱼ ∈ [symbol] is the estimated response, X_{z}^{x,j} is the user context tensor that depends on {xᵢ, xⱼ, z}, and W is the susceptibility tensor that plays the role of regression coefficients. The susceptibility tensor W is updated such that the estimated response uᵢⱼ is as close as possible to the observed user response yᵢⱼ. Elements of the tensors are represented as |⋅|ᵢ_{_{1,}}ᵢ_{_{2,}}ᵢ_{₃}. (⋅, ⋅) denotes the tensor inner product. In a 3-mode case, to be concrete, for any [symbol] and [symbol] having the same dimensionalities,

( [symbol] , [symbol] ) [symbol] Σᵢ_{_{1,}}ᵢ_{_{2,}}ᵢ_{₃}| [symbol] |ᵢ_{_{1,}}ᵢ_{_{2,}}ᵢ_{₃}| [symbol] |ᵢ_{_{1,}}ᵢ_{_{2,}}ᵢ_{₃}. (8)

The user contextual tensor (X_{z}^{x,j}) is a direct product of contextual vectors (xᵢ, xⱼ, and z). For the user contextual tensor X_{z}^{x,j}, a direct product form is used

X_{z}^{xj}=xᵢ∘x∘z (9)

where ∘ denotes the direct product, which makes X_{z}^{xj} 3-mode tensor whose (i₁, i₂, i₃)-th element is given simply by the product of three scalars:

[xᵢ∘yᵢ∘z]ᵢ_{_{1,}}ᵢ_{_{2,}}ᵢ_{₃}=x_{i,i,}_{₁}x_{j,i}_{₂}zᵢ_{₃} (10)

In order to capture the product heterogeneity and parameterize the susceptibility tensor, we exploit the canonical polyadic expansion of order R≥1 for W:

$$W = {\sum }_{r = 1}^{R} {w}^{1 r} ∘ {w}^{2 r} ∘ {w}^{3 r} , \qquad ( 11 )$$

where R is tensor rank, and where w^{1r}, w^{2r} and w^{3r} are coefficient vectors of the same dimensionality as xᵢ, xⱼ, and z, respectively. The susceptibility tensor (W) is a direct product of the coefficient vectors w^{1r}, w^{2r}, and w^{3r}). The intuition behind this expression is that, by assuming R>1, the model naturally capture different product types, as shown in FIG. 1. It is noted that that the feedback history on which [symbol] is learned generally includes different products.

The susceptibility tensor W consists of R vectors in each tensor mode to capture the diversity of the products. In the online setting, the goal is to update the regression coefficient vectors w^{lr} so that the observed user responses {y_{t,ij}} are more consistent with their predictions (W, X_{z}^{x,j}).

Now a general case is considered, where N_{F}>1. There are D feature vectors (or contextual vectors): ϕ₁∈ [symbol] ^{d}^{₁}, . . . , ϕ_{D}∈ [symbol] ^{d}^{_{D}} representing contextual information, where d₁, . . . , d_{D} are their dimensionality, respectively. In the simplest case where N_{F}=1, ϕ₁, ϕ₂, and ϕ₃ are xᵢ, xⱼ, and z, respectively. In place of equations (9) and (11), the user context and the susceptibility tensors are given by:

$$\begin{matrix}X = {ϕ}_{1} ∘ {ϕ}_{2} ∘ … ∘ {ϕ}_{D} & ( 12 ) \\ W = {\sum }_{r = 1}^{R} {w}^{1 r} ∘ {w}^{2 r} ∘ … ∘ {w}^{Dr} & ( 13 )\end{matrix}$$

Now, equation (7) can be written as:

$${u}_{i j} = {\sum }_{r = 1}^{R} {\prod }_{l = 1}^{D} {ϕ}_{l}^{T} {w}^{lr} \qquad ( 14 )$$

where w^{lr} is the coefficient vector of the r-th tensor rank for l-th contextual vector ϕᵢ, and ϕₗ^{T} denotes the transpose of ϕₗ. Equation (14) is a general representation of the parametric model H_{w} in equation (5). The tensor inner product is now reduced to the standard vector inner product under the direct-product assumption.

Now, the complexity of the proposed model is discussed. For simplicity, it is assumed that all the context vectors have the same dimensionality, d. When D contextual vectors are to be used, one naive approach is to take an outer product of these D vectors and reshape it into a vector of the dimensionality d^{D}) and solve linear regression, which requires [symbol] (d^{3D}) in the batch setting. However, equation (14) implies [symbol] (RD d³). Typically, D≥3; therefore, the estimation of the estimated response uᵢⱼ by using equation (14) has a significant reduction in complexity.

Learning Susceptibility Sensor W:

Now, how to learn W from the data is considered. In next paragraphs, samples are only with t and drop the user indexes i and j for notational simplicity, namely {(y_{τ}, X_{τ}) τ=1, . . . , t}, where X_{τ} [symbol] ϕ_{τ1} ∘ . . . ∘ ϕ_{τD} is τ-th sample of the user contextual tensor. Summations over τ up to t, for example, should be interpreted as the summation over all the samples obtained up to the time step t that include multiple sets of K seed users in general. The notation p(⋅) is used to symbolically represent probability distributions rather than a specific functional form.

For probabilistic formulation, which is required to derive the confidence bound, observation and prior distributions are used as follows:

$$\begin{matrix}p ( u \vert X , W , σ ) = N ( u \vert ( W , X ) , {σ}^{2} ) & ( 15 ) \\ p ( W ) = {\prod }_{l = 1}^{D} {\prod }_{r = 1}^{R} N ( {w}^{lr} \vert 0 , {I}_{{d}_{l}} ) & ( 16 )\end{matrix}$$

where [symbol] (⋅|(W, X), σ²) is the Gaussian distribution with the mean (W, X) and the variance σ². u ∈ [symbol] is the user response score (at any time step) for y. It is assumed that σ² is given and fixed; the assumption is a reasonable in IM as the users' response is quite sparse and estimation of the second-order statistics tends to be unstable. I_{dl} is the dₗ-dimensional identity matrix.

Based on the assumed probabilistic mode, it is desired to find the posterior distribution for {w^{lr}}. Although exact inference is intractable, an approximate posterior Q can be found by assuming a factorized form following the prescription of variational Bayes:

$$Q ( \{ {w}^{lr} \} ) = {\prod }_{l = 1}^{D} {\prod }_{r = 1}^{R} {q}^{lr} ( {w}^{lr} ) . \qquad ( 17 )$$

Here, q^{lr}(w^{lr}) can be found by minimizing the Kullback-Leibler (KL) divergence between Q ({w^{lr}}) and the true posterior, which is proportional to the complete likelihood function

$$p ( W ) {\prod }_{τ = 1}^{t} p ( {y}_{τ} \vert {X}_{τ} , W , σ ) . \qquad ( 18 )$$

Following the variational Bayes procedure, it can be shown that the posterior q^{lr}(w^{lr}) becomes the Gaussian distribution. Let q^{lr}(w^{lr}) be [symbol] (w^{lr}|w̅^{lr}, Σ^{lr}) Then, the posterior mean w̅^{lr} of coefficient vector w^{lr} is given by

$${\overline{w}}^{lr} = {σ}^{- 2} {Σ}^{lr} {\sum }_{τ = 1}^{t} {ϕ}_{τ l} {β}_{τ}^{lr} {y}_{τ}^{lr} , \qquad ( 19 )$$

where Σ^{lr} is a posterior covariance matrix of w^{lr}, ϕ_{τl} is l-th contextual vector ϕₗ at time τ and β_{τ}^{lr} and y_{τ}^{lr} are defined as:

$$\begin{matrix}{β}_{τ}^{kr} {=}^{Δ} {\prod }_{{l}^{′} \neq l} {ϕ}_{τ {l}^{′}}^{T} {\overline{w}}^{{l}^{′} r} , & ( 20 ) \\ {y}_{τ}^{lr} = {y}_{τ} - {\sum }_{{r}^{′} \neq r} ( {ϕ}_{τ l}^{T} {\overline{w}}^{{lr}^{′}} ) {β}_{τ}^{{lr}^{′}} . & ( 21 )\end{matrix}$$

Since β_{τ}^{lr} and y_{τ}^{lr} depend on the posterior means, estimation needs to be done iteratively. Notice that having R>1 amounts to fitting the residual.

The posterior covariance Σ^{lr} is given by:

$$\begin{matrix}{Σ}^{lr} = {{σ}^{2} [ {\sum }_{τ = 1}^{t} {ϕ}_{τ l} {ϕ}_{τ l}^{T} {γ}_{τ l} + {σ}^{2} {I}_{{d}_{l}} ]}^{- 1} , \\ where & ( 22 ) \\ {γ}_{τ l} {=}^{Δ} {\prod }_{{l}^{′} \neq l} {ϕ}_{τ {l}^{′}}^{T} {〈 {{\overline{w}}^{{l}^{′} r} ( {\overline{w}}^{{l}^{′} r} )}^{T} 〉}_{\backslash ( l , r )} {ϕ}_{{tl}^{′}} . & ( 23 )\end{matrix}$$

Here [symbol] ⋅ [symbol] _{\(l,r)} is the partial posterior expectation excluding q^{lr}. One issue with numerical computation of this expression is the mutual dependence of the different components of the covariance matrix. For faster and more stable computation that is suitable for sequential updating scenarios, a mean-field-type approximation is proposed:

[symbol]

w̅^{l′r}(w̅^{l′r})^{T} [symbol] _{\(l,r)}≈w̅^{l′r}(̅w^{l′r})^{T}, (24)

which gives:

γ_{τl}=(β_{τ}^{lr})². (25)

Using this, a simple formula for Σ^{lr} is obtained:

$${Σ}^{lr} = {{σ}^{2} [ {\sum }_{τ = 1}^{t} ( {β}_{τ}^{lr} {ϕ}_{τ l} ) {( {β}_{τ}^{lr} {ϕ}_{τ l} )}^{T} + {σ}^{2} {I}_{{d}_{l}} ]}^{- 1} . \qquad ( 26 )$$

Unlike the crude approximation that sets the other {w^{lr}} to a given constant, w^{lr} 's are computed iteratively over all l and r in turn, and are expected to converge to a mutually consistent value. The variance is used for comparing different edges in the upper confidence bound (UCB) framework. The approximation is justifiable since the mutual consistency matters more in our task than estimating the exact value of the variance.

Online Updates of Susceptibility Tensor W:

Now, equations of the online updates are derived. The posterior mean w̅^{lr} and covariance Σ^{lr} given in equations (19) and (26) depend on the data only through the summation over τ. For any quantity defined as Aₜ₊₁ [symbol] Σ_{τ=1}^{t}=a_{τ}, there is an update equation as Aₜ₊₁=Aₜ+aₜ in general.

When a new set of the user contextual tensor Xₜ comes in at time step t, the posterior covariance Σ^{lr} can be updated as

$$\begin{matrix}{( {Σ}^{lr} )}^{- 1} ← {( {Σ}^{lr} )}^{- 1} + {( \frac{{β}^{lr}}{σ} )}^{2} {ϕ}_{tl} {ϕ}_{tl}^{T} , & ( 27 ) \\ {Σ}^{lr} ← {Σ}^{lr} - \frac{{Σ}^{lr} {ϕ}_{tl} {ϕ}_{tl}^{T} {Σ}^{lr}}{{( \frac{σ}{{β}^{lr}} )}^{2} + {ϕ}_{lt}^{T} {Σ}^{lr} {ϕ}_{tl}} . & ( 28 )\end{matrix}$$

With the updated Σ^{lr} and a newly observed yₜ, the posterior mean w̅^{lr} is updated as

b^{lr}←b^{lr}+ϕₜₗβ^{lr}yₜ^{lr}, (29)

w̅^{lr}=σ⁻²Σ^{lr}b^{lr}. (30)

Equations (27)-(30) are performed over all (l, r) until convergence.

Upper Confidence Bound:

The learned posterior distribution Q in equation (17) with the updating equations (27)-(30) represents the model's best estimates at the time step t on the susceptibility tensor W. Formally, the predictive distribution of the user response score u can be computed by

p(u|X, [symbol] _{1:t})=∫ [symbol] (u|(W,X),σ²)Q({w^{lr}})dW, (31)

where [symbol] _{1:t} symbolically denotes the data available up to time step t. In spite of the factorized form of Q, this integration is not tractable due to the nonlinear dependency of the tensor modes and ranks. The mean-field approximation (which has been used for deriving equation (26)) is employed here to obtain

$$( W , X ) \approx \frac{1}{D} {\sum }_{r = 1}^{R} {\sum }_{l = 1}^{D} {β}^{lr} {ϕ}_{l}^{T} {w}^{lr} , \qquad ( 32 )$$

where β^{lr} has been defined in equation (20). This expression would be exact if w̅^{lr} in β^{lr} were w^{lr}. Performing the integration with the Gaussian marginalization formula obtains

$$\begin{matrix}p ( u \vert X , {D}_{1 : t} ) = 𝒩 ( y \vert \overline{u} ( X ) , {\overline{s}}^{2} ( X ) ) , \\ where & ( 33 ) \\ \overline{u} ( X ) = \frac{1}{D} {\sum }_{r = 1}^{R} {\sum }_{l = 1}^{D} {β}^{lr} {ϕ}_{l}^{T} {\overline{w}}^{lr} = {\sum }_{r = 1}^{R} {\prod }_{l = 1}^{D} {( {\overline{w}}^{lr} )}^{T} {ϕ}_{l} , & ( 34 ) \\ {\overline{s}}^{2} ( X ) = {σ}^{2} + \frac{1}{D} {\sum }_{r = 1}^{R} {\sum }_{l = 1}^{D} {( {β}^{lr} {ϕ}_{l} )}^{T} {\sum }^{lr} ( {β}^{lr} {ϕ}_{l} ) . & ( 35 )\end{matrix}$$

Equations (34) and (35) are used to predict the expected value and the variance of user's response for any X (any user pair and product).

Use the expected value plus an error bar, instead of the expected value alone, to compare different options. A graph node may be chosen as a seed because of a large activation probability, or a large uncertainty. The algorithm nicely mixes the two possibilities. Although simple, this is a powerful idea to achieve the exploration-exploitation trade-off in EDA.

Since the predictive distribution is Gaussian, (a Bayesian counterpart of) the upper confidence bound is provided. Specifically, let h_{δ} be the deviation from the mean corresponding to the tail probability 0<δ<1. By the Chernoff bound of Markov's inequality, it is obtained:

$${\int }_{\vert y - \overline{u} \vert \geq {h}_{δ}} p ( y \vert X , {D}_{1 : t} ) d y \leq 2 exp ( - \frac{{h}_{δ}^{2}}{2 {s}^{2}} ) \qquad ( 36 )$$

Equating the right hand side above to δ obtains:

$${h}_{δ} = \sqrt{2 ln ( \frac{2}{δ} )} \overline{s} ( X ) . \qquad ( 37 )$$

Since σ² is a constant and (β^{lr}ϕₗ)^{T}Σ^{lr}(β^{lr}ϕₗ)≥0 in equation (35), it suffices to use

$$\begin{matrix}{p}_{t , ij} ← proj ( \overline{u} ( {X}_{t} ) + {CB}_{t}^{i j} ) , & ( 38 ) \\ {CB}_{t}^{ij} {=}^{Δ} c {\sum }_{r = 1}^{R} {\sum }_{l = 1}^{D} \sqrt{{( {β}^{lr} {ϕ}_{tl} )}^{T} {Σ}^{lr} ( {β}^{lr} {ϕ}_{tl} )} & ( 39 )\end{matrix}$$

for the exploration-exploitation trade-off, where the proj operator maps a real value onto [0, 1]. For example, mapping a real value onto [0, 1] can be done by using the sigmoid function, the clipping function, etc. c is a constant of at most [symbol] (1) under the assumption ∥β^{lr}ϕₜₗ∥≤1 for all (l, r). It is assumed that Xₜ is between the i-th user and j-th user.

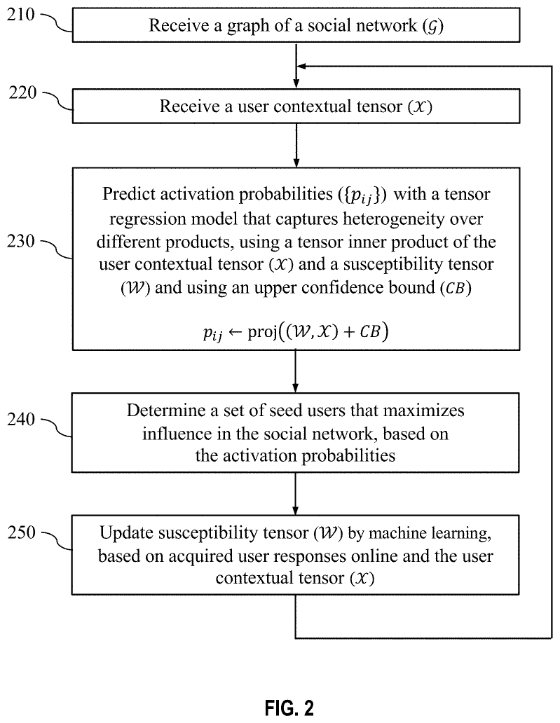

FIG. 2 presents a flowchart showing operational steps of a framework with tensor bandits and an upper confidence bound for influence maximization (IM), in accordance with one embodiment of the present invention. The operational steps are implemented by a computing device or a sever. At step 210, the computing device or server receives a graph of a social network ( [symbol] ). For the given social network graph [symbol] =(ν, ε), ν is the set of user nodes and ε is the set of edges representing the friendship between the users. At step 220, the computing device or server receives a user contextual tensor (X). The user contextual tensor is formed by D feature vectors (or contextual vectors): ϕ₁, ϕ₂, . . . , ϕ_{D} and the user contextual tensor represents contextual information. In the example shown in FIG. 1, ϕ₁, ϕ₂, and ϕ₃ are xᵢ, xⱼ, and z, respectively, and the user contextual tensor X_{z}^{ij} that is formed from three feature vectors: user feature vectors of the i-th user and j-th user (xᵢ and xⱼ) and a product feature vector z.

At step 230, the computing device or server predicts activation probabilities ({pᵢⱼ}) with a tensor regression model that captures heterogeneity over different products, using a tensor inner product of the user contextual tensor (X) and a susceptibility tensor (W) and using an upper confidence bound (CB). pᵢⱼ is a probability for the i-th user to activate the j-th user, and it can be predicts by the tensor regression model and the introduced upper confidence bound: (W, X)+CB. The tensor (W) plays a role of regression coefficients in the tensor regression model. The upper confidence bound (CB) is used for exploration-exploitation trade-off in exploratory data analysis. In the example shown in FIG. 1, pᵢⱼ is predicted by an projection operation, as shown in equation (1) (presented in previous paragraphs):

pᵢⱼ←proj((W,X_{z}^{ij})+CB_{z}^{ij}). (1)

where the proj operator maps a real value onto [0, 1].

At step 240, the computing device or server determines a set of seed users that maximizes influence in the social network, based on the activation probabilities. Once the activation probabilities ({pᵢⱼ}) are predicted at step 230, the activation probability matrix [symbol] =[pᵢⱼ] is obtained. A submodular maximization algorithm denoted as ORACLE in the present invention is used to choose K most influential users (or the seed users) that maximizes the influence in the social network. ORACLE is a function of K and the activation probability matrix [symbol] , as shown in equation (2) (presented in previous paragraphs):

S=ORACLE( [symbol] ,K), (2)

where S denotes the set of K selected users (or seed users).

At step 250, the computing device or server updates the susceptibility tensor (W) by machine learning, based on acquired user responses online and the user contextual tensor (X). In response to that a predetermined number of rounds of online updates is not reached, the computing device or server updates the susceptibility tensor (W) in the tensor regression model, based on the acquired user responses yᵢⱼ (response of j-th user under influence of i-th user) and the user contextual tensor (X). Then, the computing device or server reiterates steps 220-240. In a new cycle of the reiteration, the computing device or server may receive a new user contextual tensor (X); for example, the computing device or server may receive one or more new product contextual vectors for a new round of marketing campaign. Based on the new user contextual tensor (X) and updated susceptibility tensor (W) obtained at step 250, the computing device or server updates the activation probabilities {pᵢⱼ} and obtains a new activation probability matrix [symbol] . Based on the new activation probability matrix [symbol] , the computing device or server determines a new set of K selected users (or seed users), using the submodular maximization algorithm. Unless the predetermined number of rounds is reached, the computing device or server then executes step 250 to update susceptibility tensor (W) and starts another cycle of the reiteration of steps 220-240. Through predetermined number of rounds of the online updates, the computing device or server maximizes the influence over the other users.

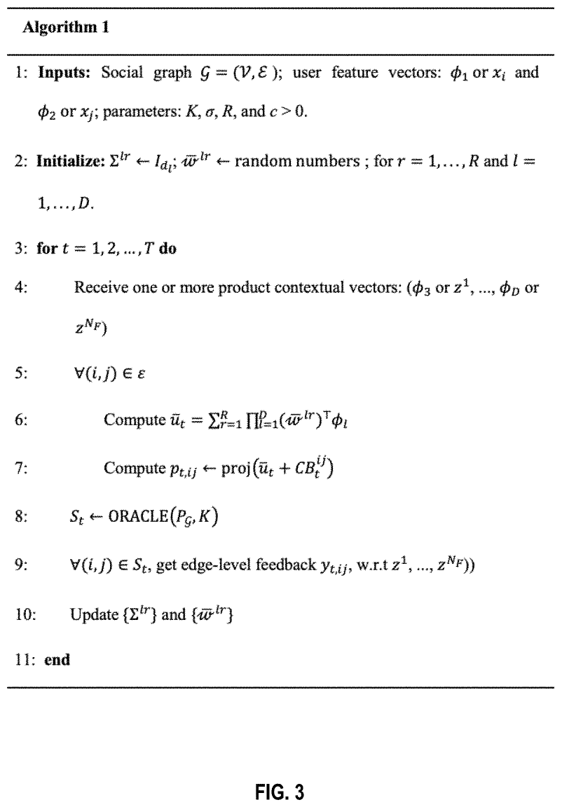

FIG. 3 presents an algorithm of using a tensor regression model and online updates for influence maximization (IM), in accordance with one embodiment of the present invention. In FIG. 3, Algorithm 1 summarizes an algorithm using tensor bandits and an upper confidence bound for influence maximization (TensorUCB algorithm).

Sₜ is the set of K selected users at the t-th round. The algorithm takes four parameters: K, σ, R, and c. The budget K is determined by business requirements. The variance of user feedback σ² is typically fixed to a value of [symbol] (1) such as 0.1. The parameters R and c have to be cross-validated. For the choice of R, the average regret tends to improve as R increases to a certain value.

In the algorithm, edge level feedback y_{t,ij} is used. In practice, the node-level feedback is easy to obtain than the edge-level feedback. Algorithm 1 can be adapted to node-level feedback by randomly assigning the credit to one of the (active) parents/neighbors of each activated node, uniformly at random. Then, the proposed TensorUCB updates for the edge-level feedback is performed.

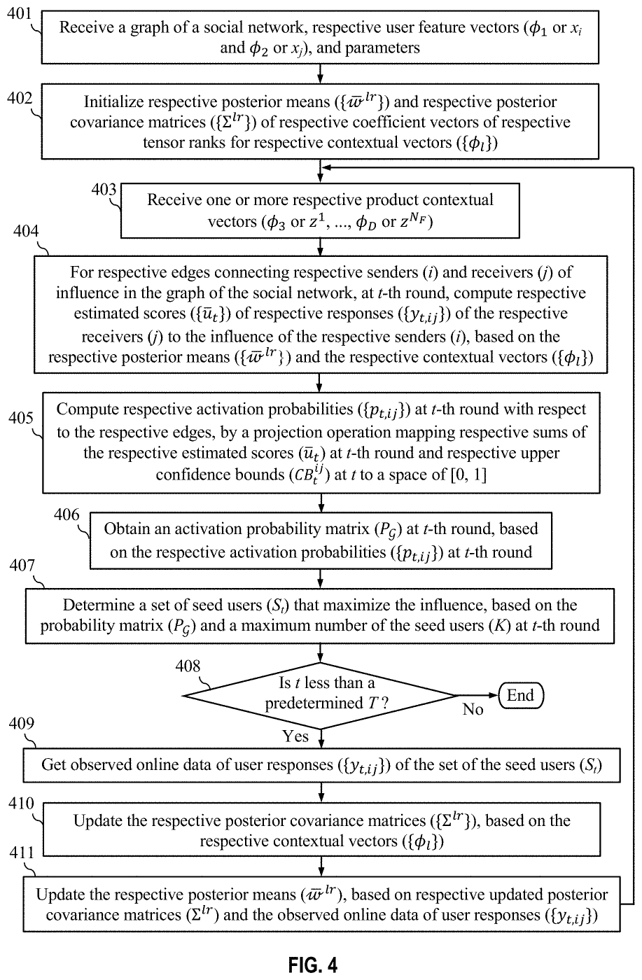

FIG. 4 presents a flowchart showing detailed operational steps of using a tensor regression model and online updates for influence maximization (IM), in accordance with one embodiment of the present invention. The operational steps are implemented by a computing device or a sever.

At step 401, the computing device or sever receives a graph of a social network ( [symbol] =(ν, ε)), respective user feature vectors (ϕ₁ or xᵢ and ϕ₂ or xⱼ), and parameters. The social graph [symbol] =(ν, ε) has ν nodes representing users and ε edges representing the relationships between the users. The user feature vectors (ϕ₁ or xᵢ and ϕ₂ or xⱼ) are a pair of user feature vectors for each selected user pair (i, j). The parameters include budget K, variance of user feedback σ², tensor rank R, and exploration-exploitation trade-off coefficient c>0. The budget K is the number of seed users chosen from the graph nodes and is determined by business requirements. The variance of user feedback σ² is typically fixed to a value of [symbol] (1) such as 0.1. A given value of tensor rank R affects the average regret and increasing the R value to a certain value improves the average regret.

At step 402, the computing device or sever initializes respective posterior means ({w̅^{lr}}) and respective posterior covariance matrices {Σ^{lr}}) of respective coefficient vectors ({w^{lr}}) of respective tensor ranks for the respective contextual vectors ({ϕₗ}). As described in previous paragraphs of this document, r=1, . . . , R and l=1, . . . , D, where R is the tensor rank and D is the number of contextual vectors (ϕ₁ . . . , ϕ_{D}). A posterior mean (w̅^{lr}) is defined by equation (19) and a posterior covariance matrix (Σ^{lr}) is defined by equation (26). A coefficient vector w^{lr} is the coefficient vector of the r-th tensor rank for l-th contextual vector ϕ₁; ϕₗ and w^{lr} are described in equations (12) and (13). For example, a value of w̅^{lr} is initiated with a random number, and a posterior covariance matrix (Σ^{lr}) is initiated with a dₗ-dimensional identity matrix I_{dl}.

At step 403, t-th round of online update or marketing campaign starts. The computing device or sever receives one or more respective product contextual vectors (ϕ₃ or z₁, . . . , ϕ_{D} or z_{N_F}). For the simplest case described in previous paragraphs and FIG. 1 of this document, N_{F}=1; a product contextual vector is z. For each round of the online update or the marketing campaign, the computing device or sever may receive one or more new product contextual vectors for a new marketing campaign.

At step 404, the computing device or sever, at t-th round of online update or marketing campaign, for respective edges connecting respective senders (i) and receivers (j) of influence in the graph of the social network, computes respective estimated scores ({ūₜ}) of respective responses ({y_{t,ij}}) of the respective receivers (j) to the influence of the respective senders (i), based on the respective posterior means ({w̅^{lr}}) and the respective contextual vectors ({ϕₗ}). For each of the respective edges, the computation of an estimated scores (ūₜ) is based on equation (34) which is described in previous paragraphs of this document:

$$\overline{u} ( X ) = {\sum }_{r = 1}^{R} {\prod }_{l = 1}^{D} {( {\overline{w}}^{lr} )}^{T} {ϕ}_{l} . \qquad ( 34 )$$

At step 405, the computing device or sever computes respective activation probabilities ({p_{t, ij}}) at t-th round with respect to the respective edges, by a projection operation mapping respective sums of the respective estimated scores ({ūₜ}) at t-th round and respective upper confidence bounds ({CBₜ^{ij}}) at t-th round to a space of [0, 1]. To address exploration-exploitation trade-off in EDA, the upper confidence bounds are introduced. For each of the respective edges, the computation of an upper confidence bound is based on equation (39) which is described in previous paragraphs of this document:

$${CB}_{t}^{ij} {=}^{Δ} c {\sum }_{r = 1}^{R} {\sum }_{l = 1}^{D} \sqrt{{( {β}^{lr} {ϕ}_{tl} )}^{T} {Σ}^{lr} ( {β}^{lr} {ϕ}_{tl} )} . \qquad ( 39 )$$

For each of the respective edges, an activation probability p_{t,ij} at t-th round is computed by an projection operation shown in equation (38) which is described in previous paragraphs of this document:

p_{t,ij}←proj(ū(Xₜ)+CBₜ^{ij}). (38)

The proj operator maps a real value onto [0, 1]. Mapping a real value onto [0, 1] can be done by using the sigmoid function, the clipping function, etc. At step 406, the computing device or sever obtains an activation probability matrix [symbol] at t-th round, based on the respective activation probabilities ({p_{t, ij}}) at t-th round.

At step 407, the computing device or sever determines a set of seed users (Sₜ) that maximize the influence, based on the probability matrix ( [symbol] ) and a maximum number of the seed users (K) at t-th round. Determining the set of seed users (Sₜ) uses a submodular maximization algorithm denoted as ORACLE shown in equation (2) which is described in previous paragraphs of this document:

S=ORACLE( [symbol] ,K) (2)

At step 408, the computing device or sever determines whether t is less than a predetermined T. The predetermined T is a predetermined maximum number of rounds of online updates. In response to determining that t is not less than a predetermined T (No branch of step 408), the computing device or sever finds a final set of seed users (S) that maximize the influence and terminates further online updates. In response to determining that t is less than a predetermined T (Yes branch of step 408), at step 409, the computing device or sever gets observed online data of the user responses ({y_{t,ij}}) of the set of the seed users.

At step 410, the computing device or sever updates the respective posterior covariance matrices based on the respective contextual vectors ({ϕₗ}). Updating the respective posterior covariance matrices (Σ^{lr}) uses equations (27) and (28) which are described in previous paragraphs of this document:

$$\begin{matrix}{( {Σ}^{lr} )}^{- 1} ← {( {Σ}^{lr} )}^{- 1} + {( \frac{{β}^{lr}}{σ} )}^{2} {ϕ}_{tl} {ϕ}_{tl}^{T} , & ( 27 ) \\ {Σ}^{lr} ← {Σ}^{lr} - \frac{{Σ}^{lr} {ϕ}_{tl} {ϕ}_{tl}^{T} {Σ}^{lr}}{{( \frac{σ}{{β}^{lr}} )}^{2} + {ϕ}_{lt}^{T} {Σ}^{lr} {ϕ}_{tl}} . & ( 28 )\end{matrix}$$

At step 411, the computing device or sever updates the respective posterior means ({w̅^{lr}}) based on respective updated posterior covariance matrices ({Σ^{lr}}) and the observed online data of the user responses ({y_{t,ij}}). In updating the respective posterior means ({w̅^{lr}}) the respective updated posterior covariance matrices ({Σ^{lr}}) are used and they are obtained at step 410. In updating the respective posterior means ({w̅^{lr}}) the observed online data of the user responses ({y_{t,ij}}) are also used and they are obtained at step 409. Updating the respective posterior means ({w̅^{lr}}) uses equations (29) and (30) which are described in previous paragraphs of this document:

b^{lr}←b^{lr}+ϕₜₗβ^{lr}yₜ^{lr}, (29)

w̅^{lr}=σ⁻²Σ^{lr}b^{lr}. (30)

Through updating the respective posterior covariance matrices ({Σ^{lr}}) at step 410 and updating the respective posterior means ({w̅^{lr}}) at step 411, the computing device and server updates the susceptibility tensor (W) by machine learning, using an online learning algorithm.

After updating the respective posterior covariance matrices ({Σ^{lr}}) at step 410 and updating the respective posterior means ({w̅^{lr}}) at step 411, the computing device and server reiterates steps 403-408 and starts a new round (t+1 round) of online update or marketing campaign.

The proposed method of the present invention was evaluated against the state-of-the-art baselines on publicly available real-world datasets: Digg and Flixster. Digg is a social news website where users vote for stories. The interaction log contains data on which user voted for which story (item) at which time, and Flixster is a social movie rating company and the log contains user ratings of movies with timestamps. In all these datasets, isolated/unreachable nodes and nodes with less than 50 interactions in the log were removed. In the experiments, the final graph [symbol] for Digg included 2843 nodes and 75,895 edges along with 1000 items (stories), and the final graph [symbol] for Flixster included 29,384 nodes and 371,722 edges with 100 items (movies). The user feature vectors were constructed from [symbol] using the Laplacian eigenmap, in which the bottom ten eigenvectors with the smallest eigenvalues of the unweighted Laplacian matrix were used. This feature construction approach captures the network topology, especially the node degrees, while providing user features varying smoothly over [symbol] .

An experiment setting was considered for advertising campaigns in multiple product case. At each campaign round t, a new product (or one of the previously selected products) was chosen for the campaign. In addition to the user feature vectors, it was assumed that item feature vectors from the product descriptions were available as one of the contextual features for the online IM. The goal of this experiment was to study the effect of considering multiple products in estimating the activation probability. To demonstrate the performance of different online IM approaches in the multiple product setting, both the Digg and Flixster datasets were considered for this experiment. Since the Digg dataset included more items than the total number of campaign rounds (1000 items vs 200 rounds), it accentuated the importance for the online IM models to learn the activation probability from potentially new products at each round by leveraging the item features. In contrast, the Flixster dataset included 100 items (over 200 campaign rounds), allowing the online IM models to leverage the knowledge learned from the previous campaigns more readily. In either case of the two cases of the multiple product setting, the online IM methods were challenged to adapt to the new products by generalizing the knowledge learned from the previous campaigns with different products.

The proposed method (TensorUCB) of the present invention was compared with five baseline methods. The first baseline was Random which selected the seeds for a given round randomly. The second baseline was COIN proposed by Saritac et al. (Online Contextual Influence Maximization in Social Networks, Fifty-fourth Annual Allerton Conference, 2016); with COIN, the item feature contextual space was partitioned/clustered and a separate (Thompson sampling-based) online IM model was learned for each partition independently. The third baseline was DILinUCB proposed by Vaswani et al., (Model-Independent Online Learning for Influence Maximization, Proceedings of the 34th International Conference on Machine Learning, 2017); DILinUCB learned the (pairwise) reachability probability between any two nodes using the source (seed) vector of the influencing node and the user feature for the target node. The fourth baseline was IMFB proposed by Wu et al. (Factorization Bandits for Online Influence Maximization, 25th ACM SIGKDD Conference on Knowledge Discovery and Data Mining, 2019); IMFB ignored the contextual features completely and learned two weight vectors for each node: the source vector and the target vector. The fifth baseline was IMLinUCB proposed by Wen et al., (Online Influence Maximization under Independent Cascade Model with Semi-Bandit Feedback, 31st Conference on Neural Information Processing Systems, 2017); IMLinUCB estimated the activation probabilities using edge features and computed the edge features using the element-wise product of user features of the two nodes connected to their edge.

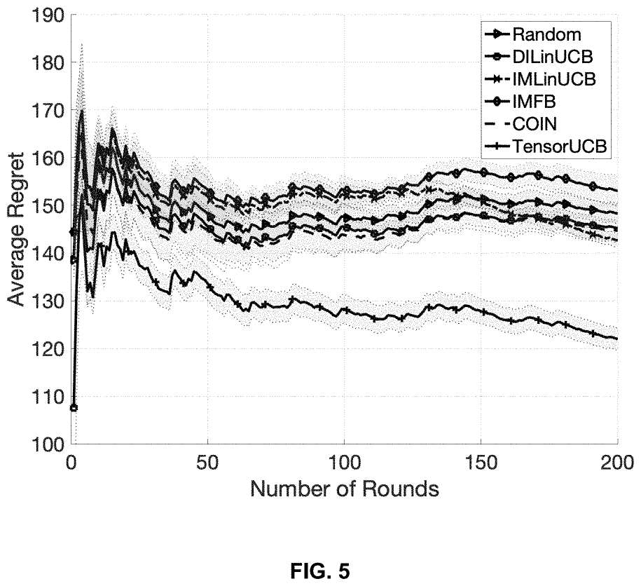

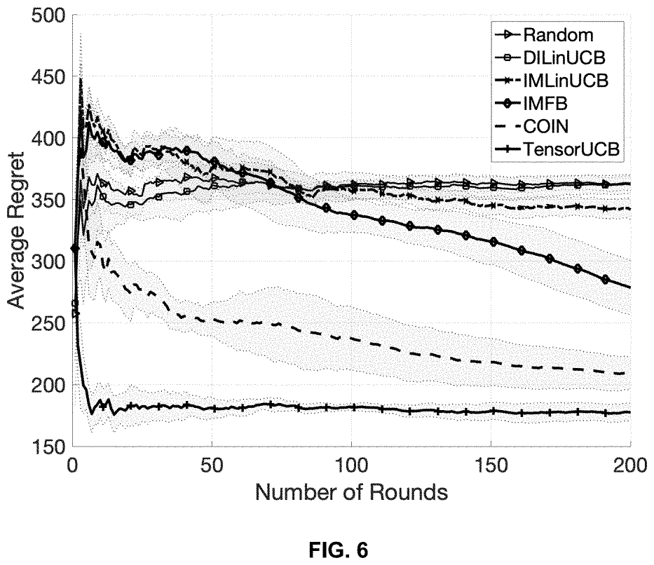

FIG. 5 presents a first experimental result of using a framework with tensor bandits and an upper confidence bound for influence maximization (IM) and comparison of the first experimental result with results of baselines, in accordance with one embodiment of the present invention. The first experimental result was from a experiment with the Digg dataset. FIG. 6 presents a second experimental result of using a framework with tensor bandits and an upper confidence bound for influence maximization (IM) and comparison of the second experimental result with results of baselines, in accordance with one embodiment of the present invention. The second experimental result was from a experiment with the Flixster dataset. In both the experiments, the baselines included Random, COIN, DILinUCB, IMFB, and IMLinUCB.

Experimental results shown in FIG. 5 and FIG. 6 indicated that the proposed method (TensorUCB) of the present invention outperformed other state-of-the-art baselines in the multiple product case on both Digg dataset with 1000 items (stories) and Flixster dataset with 100 items (movies). As shown in FIG. 5, in the experiment with the Digg dataset, most of the baselines (DILinUCB, IMFB, and COIN) performed similarly to the random baseline as they struggled to adapt to the new products at each product campaign round. From the experimental results, it was observed that the baselines that did not adapt to a dynamic environment underperformed significantly. Unlike the baselines, the proposed method (TensorUCB) learned the activation probability by leveraging the interaction between the user and item features efficiently for the new products, whereas the baseline methods achieve high regret for ignoring the structure of the (user and item) contextual features to adapt to the new products. Surprisingly, IMLinUCB performed better at later rounds of the campaign in the Digg dataset; this might be because learning a latent weight vector for the entire network helped in identifying the common influence pattern between the users across the different products.

As shown in FIG. 6, in the experiment with the Flixster dataset, the baseline COIN performed better than the other baselines. Unlike the proposed method TensorUCB, COIN ignored the contextual information (both user and item feature vectors) for choosing a good set of seed sets and build a new IM model for each partition separately. TensorUCB smoothly learned the activation probability based on the available contextual features and leveraged the knowledge learned from the earlier interactions with the network. Both IMFB and IMLinUCB outperformed the random baseline, as they capture the item-specific knowledge from the previous products efficiently. Since IMFB learned a latent item feature vector for each node by matrix factorization, in contrast to a latent weight vector learned for the entire network in IMLinUCB, IMFB leveraged the item-specific knowledge better than IMLinUCB. Model independent DILinUCB performed the worst on average in both datasets as it suffered from the exploration bottleneck for each unique product campaign.

FIG. 7 is a diagram illustrating components of computing device or server 700, in accordance with one embodiment of the present invention. It should be appreciated that FIG. 7 provides only an illustration of one implementation and does not imply any limitations with regard to the environment in which different embodiments may be implemented.

Referring to FIG. 7, computing device or server 700 includes processor(s) 720, memory 710, and tangible storage device(s) 730. In FIG. 7, communications among the above-mentioned components of computing device or server 700 are denoted by numeral 790. Memory 710 includes ROM(s) (Read Only Memory) 711, RAM(s) (Random Access Memory) 713, and cache(s) 715. One or more operating systems 731 and one or more computer programs 733 reside on one or more computer readable tangible storage device(s) 730.

Computing device or server 700 further includes I/O interface(s) 750. I/O interface(s) 750 allows for input and output of data with external device(s) 760 that may be connected to computing device or server 700. Computing device or server 700 further includes network interface(s) 740 for communications between computing device or server 700 and a computer network.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the C programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 8, illustrative cloud computing environment 50 is depicted. As shown, cloud computing environment 50 includes one or more cloud computing nodes 10 with which local computing devices are used by cloud consumers, such as mobile device 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N are intended to be illustrative only and that computing nodes 10 and cloud computing environment 50 can communicate with any type of computerized device over any type of network and/or network addressable connection (e.g., using a web browser).

Referring now to FIG. 9, a set of functional abstraction layers provided by cloud computing environment 50 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and function 96. Function 96 in the present invention is the functionality of a framework with tensor bandits and an upper confidence bound for influence maximization (IM).

What is claimed is:

1. A computer-implemented method for influence maximization on a social network, the method comprising:
receiving a graph of a social network and a user contextual tensor;
predicting activation probabilities of respective first users influencing respective second users, with a tensor regression model, using a tensor inner product of the user contextual tensor and a susceptibility tensor and using an upper confidence bound;
determining a set of seed users that maximizes influence in the social network, based on the activation probabilities;
updating the susceptibility tensor by machine learning, based on user responses online and the user contextual tensor; and
updating the activation probabilities and the set of the seed users, based on an updated susceptibility tensor.

2. The computer-implemented method of claim 1, further comprising:
receiving the graph of the social network, respective user feature vectors, and parameters; and
initializing respective posterior means and respective posterior covariance matrices of respective coefficient vectors of respective tensor ranks for respective contextual vectors.

3. The computer-implemented method of claim 2, further comprising:
receiving one or more respective product contextual vectors;
for respective edges connecting the respective first users and the respective second users in the graph of the social network, computing respective estimated scores of respective responses of the respective first users and the respective second users, based on the respective posterior means and the respective contextual vectors;
computing respective ones of the activation probabilities with respect to the respective edges;
obtaining an activation probability matrix, based on the respective ones of the activation probabilities;
determining the set of the seed users that maximize the influence, based on the probability matrix and a maximum number of the seed users; and
determining whether a predetermined number of rounds of online updates is reached.

4. The computer-implemented method of claim 3, further comprising:
in determining that the predetermined number of the rounds of the online updates is reached, determining a final set of the seed users that maximize the influence.

5. The computer-implemented method of claim 3, further comprising:
in determining that the predetermined number of the rounds of the online updates is not reached, obtaining observed online data of user responses of the set of the seed users;
updating the respective posterior covariance matrices, based on the respective user feature vectors and the one or more respective product contextual vectors;
updating the respective posterior means, based on respective updated posterior covariance matrices and the observed online data of the user responses of the set of the seed users; and
executing a round of an online update, based on the respective updated posterior covariance matrices and respective updated posterior means.

6. The computer-implemented method of claim 3, wherein, for computing respective ones of the activation probabilities, a projection operation maps respective sums of the respective estimated scores and respective upper confidence bounds to a space of [0, 1].

7. The computer-implemented method of claim 1, wherein the tensor regression model captures heterogeneity over different products.

8. A computer program product for influence maximization on a social network, the computer program product comprising a computer readable storage medium having program instructions embodied therewith, the program instructions executable by one or more processors, the program instructions executable to:
receive a graph of a social network and a user contextual tensor;
predict activation probabilities of respective first users influencing respective second users, with a tensor regression model, using a tensor inner product of the user contextual tensor and a susceptibility tensor and using an upper confidence bound;
determine a set of seed users that maximizes influence in the social network, based on the activation probabilities;
update the susceptibility tensor by machine learning, based on user responses online and the user contextual tensor; and
update the activation probabilities and the set of the seed users, based on an updated susceptibility tensor.

9. The computer program product of claim 8, further comprising the program instructions executable to:
receive the graph of the social network, respective user feature vectors, and parameters; and
initialize respective posterior means and respective posterior covariance matrices of respective coefficient vectors of respective tensor ranks for respective contextual vectors.

10. The computer program product of claim 9, further comprising the program instructions executable to:
receive one or more respective product contextual vectors;
for respective edges connecting the respective first users and the respective second users in the graph of the social network, compute respective estimated scores of respective responses of the respective first users and the respective second users, based on the respective posterior means and the respective contextual vectors;
compute respective ones of the activation probabilities with respect to the respective edges;
obtain an activation probability matrix, based on the respective ones of the activation probabilities;
determine the set of the seed users that maximize the influence, based on the probability matrix and a maximum number of the seed users; and
determine whether a predetermined number of rounds of online updates is reached.

11. The computer program product of claim 10, further comprising the program instructions executable to:
in determining that the predetermined number of the rounds of the online updates is reached, determine a final set of the seed users that maximize the influence.

12. The computer program product of claim 10, further comprising the program instructions executable to:
in determining that the predetermined number of the rounds of the online updates is not reached, obtain observed online data of user responses of the set of the seed users;
update the respective posterior covariance matrices, based on the respective user feature vectors and the one or more respective product contextual vectors;
update the respective posterior means, based on respective updated posterior covariance matrices and the observed online data of the user responses of the set of the seed users; and
execute a round of an online update, based on the respective updated posterior covariance matrices and respective updated posterior means.

13. The computer program product of claim 10, wherein, for computing respective ones of the activation probabilities, a projection operation maps respective sums of the respective estimated scores and respective upper confidence bounds to a space of [0, 1].

14. The computer program product of claim 8, wherein the tensor regression model captures heterogeneity over different products.

15. A computer system for influence maximization on a social network, the computer system comprising one or more processors, one or more computer readable tangible storage devices, and program instructions stored on at least one of the one or more computer readable tangible storage devices for execution by at least one of the one or more processors, the program instructions executable to:
receive a graph of a social network and a user contextual tensor;
predict activation probabilities of respective first users influencing respective second users, with a tensor regression model, using a tensor inner product of the user contextual tensor and a susceptibility tensor and using an upper confidence bound;
determine a set of seed users that maximizes influence in the social network, based on the activation probabilities;
update the susceptibility tensor by machine learning, based on user responses online and the user contextual tensor; and
update the activation probabilities and the set of the seed users, based on an updated susceptibility tensor.

16. The computer system of claim 15, further comprising the program instructions executable to:
receive the graph of the social network, respective user feature vectors, and parameters; and
initialize respective posterior means and respective posterior covariance matrices of respective coefficient vectors of respective tensor ranks for respective contextual vectors.

17. The computer system of claim 16, further comprising the program instructions executable to:
receive one or more respective product contextual vectors;
for respective edges connecting the respective first users and the respective second users in the graph of the social network, compute respective estimated scores of respective responses of the respective first users and the respective second users, based on the respective posterior means and the respective contextual vectors;
compute respective ones of the activation probabilities with respect to the respective edges;
obtain an activation probability matrix, based on the respective ones of the activation probabilities;
determine the set of the seed users that maximize the influence, based on the probability matrix and a maximum number of the seed users; and
determine whether a predetermined number of rounds of online updates is reached.

18. The computer system of claim 17, further comprising the program instructions executable to:
in determining that the predetermined number of the rounds of the online updates is reached, determine a final set of the seed users that maximize the influence.

19. The computer system of claim 17, further comprising the program instructions executable to:
in determining that the predetermined number of the rounds of the online updates is not reached, obtain observed online data of user responses of the set of the seed users;
update the respective posterior covariance matrices, based on the respective user feature vectors and the one or more respective product contextual vectors;
update the respective posterior means, based on respective updated posterior covariance matrices and the observed online data of the user responses of the set of the seed users; and
execute a round of an online update, based on the respective updated posterior covariance matrices and respective updated posterior means.

20. The computer system of claim 17, wherein, for computing respective ones of the activation probabilities, a projection operation maps respective sums of the respective estimated scores and respective upper confidence bounds to a space of [0, 1].
